(19) United States
(12) Patent Application Publication
(10) Pub. No.: US 2026/0312470 A1
(43) Pub. Date: Oct. 8, 2026

(54) MOTOR DRIVE DEVICE AND MOTOR DRIVE DEVICE UNIT

(71) Applicant: Fanuc Corporation, Minamitsuru-gun, Yamanashi (JP)

(72) Inventor: Yuhiro INAGAKI, Minamitsuru-gun, Yamanashi (JP)

(73) Assignee: Fanuc Corporation, Minamitsuru-gun, Yamanashi (JP)

(21) Appl. No.: 19/479,595

(22) PCT Filed: May 10, 2023
(86) PCT No.: PCT/JP2023/017576

§ 371 Date: Oct. 28, 2025

(51) Int. Cl. H02K 11/33; H02K 11/00

(52) U.S. Cl. CPC H02K 11/33; H02K 11/0094

(57) ABSTRACT

Conventionally, it has been required to simplify a wiring structure connected to a motor drive device and enhance the efficiency of work such as maintenance work on the motor drive device. This motor drive device for driving a motor comprises: a wiring part in which first wiring for transmitting a first signal communicated with the motor and second wiring for transmitting a second signal communicated with another apparatus are connected, and which includes a wiring-side contact for communicating the first signal and the second signal; and a main body part which is removably attached to the wiring part and provided with a built-in electronic component for processing the first signal and the second signal, the main body part having a main body-side contact that is in conductive contact with the wiring-side contact when the main body part is attached to the wiring part.

### CROSS REFERENCE TO RELATED APPLICATION

This is the U.S. National Phase application of PCT/JP2023/017576, filed May 10, 2023, the disclosure of this application being incorporated herein by reference in its entirety for all purposes.

### FIELD OF INVENTION

The present disclosure relates to a motor drive device and a motor drive device unit.

### BACKGROUND OF THE INVENTION

A motor drive device that supplies power to a motor is known (e.g., Patent Literature 1).

### PATENT LITERATURE

PTL 1: JP 11-202921 A

### SUMMARY OF THE INVENTION

Conventionally, there is a demand for simplifying a wiring structure connected to a motor drive device and increasing efficiency of work such as maintenance of the motor drive device.

In one aspect of the present disclosure, a motor drive device configured to drive a motor includes a wiring part to which a first wiring via which a first signal communicated with the motor is transmitted and a second wiring via which a second signal to be communicated with another apparatus is transmitted are connected, the wiring part including a wiring-side contact for communication of the first signal and the second signal; and a main body detachably attached to the wiring part and incorporating an electronic component configured to process the first signal and the second signal, the main body including a main body-side contact brought into conductive contact with the wiring-side contact when the main body is attached to the wiring part.

### BRIEF DESCRIPTION OF DRAWINGS

FIG. 1 is a block diagram of an industrial machine system according to an embodiment.

FIG. 2 is a front view of a plurality of motor drive devices illustrated in FIG. 1.

FIG. 3 is a side view of the motor drive device illustrated in FIG. 2.

FIG. 4 is a perspective view illustrating wiring parts illustrated in FIG. 2.

FIG. 5 is a diagram for describing an attachment motion of a main body to the wiring part in the motor drive device illustrated in FIG. 3.

FIG. 6 is a cross-sectional view of a guide mechanism illustrated in FIG. 3.

FIG. 7 is a side view of a motor drive device according to another embodiment.

FIG. 8 is a diagram for describing an attachment motion of the main body to the wiring part in the motor drive device illustrated in FIG. 7.

FIG. 9 is a side view of a motor drive device according to still another embodiment.

FIG. 10 is a diagram for describing an attachment motion of the main body to a wiring part in the motor drive device illustrated in FIG. 9.

FIG. 11 is a side view of a motor drive device according to yet another embodiment.

FIG. 12 is a side view of a motor drive device according to a further embodiment.

FIG. 13 is a side view of a motor drive device according to a still further embodiment.

FIG. 14 is a side view of a motor drive device according to a yet further embodiment.

FIG. 15 is an enlarged view of a main portion of the motor drive device illustrated in FIG. 14.

FIG. 16 is a side view of a motor drive device according to still another embodiment.

FIG. 17 is a side view of a motor drive device according to yet another embodiment.

FIG. 18 is an enlarged view of conductive pads illustrated in FIG. 17.

FIG. 19 is a side view of a motor drive device according to a further embodiment.

FIG. 20 illustrates a state in which a main body is arranged at an attachment position in the motor drive device illustrated in FIG. 19.

FIG. 21 is a perspective view of a male connector and a female connector that are illustrated in FIG. 19.

FIG. 22 illustrates a state in which the male connector illustrated in FIG. 21 is inserted into the female connector from a first direction.

FIG. 23 illustrates a state in which the male connector illustrated in FIG. 21 is inserted into the female connector from a second direction.

FIG. 24 is a block diagram of an industrial machine system according to a still further embodiment.

FIG. 25 is a side view of a motor drive device illustrated in FIG. 24.

### DETAILED DESCRIPTION OF EMBODIMENTS OF THE INVENTION

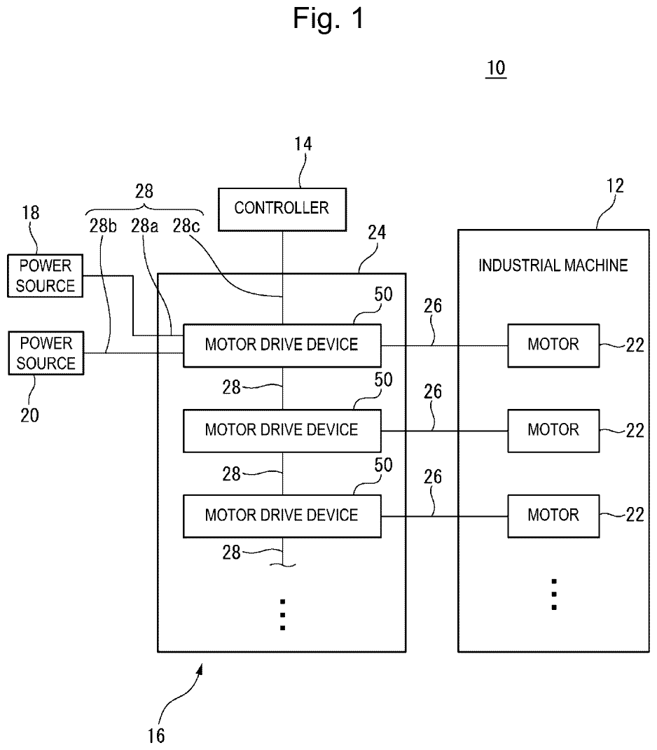

Embodiments of the present disclosure will be described in detail below with reference to the drawings. Note that in the various embodiments described below, similar elements are denoted by the same reference signs, and duplicate descriptions will be omitted. First, referring to FIG. 1, an industrial machine system 10 according to an embodiment will be described. The industrial machine system 10 includes an industrial machine 12, a controller 14, a motor drive device unit 16, and power sources 18 and 20.

The industrial machine 12 is, for example, a machine tool that machines a workpiece or a robot that performs a predetermined work (workpiece handling, welding, laser processing, or the like) on a workpiece, and includes a plurality of motors (for example, servo motors) 22. The controller 14 is a computer including a processor (CPU, GPU, or the like) and a memory (RAM, ROM, or the like) and controls the operation of the industrial machine 12. Specifically, the controller 14 generates a control signal Sc for controlling each of the motors 22, and controls the operation of the industrial machine 12 by driving the motor 22 according to the control signal Sc. The control signal Sc includes, for example, a command (position command or the like) to the motor 22.

The motor drive device unit 16 includes a rack 24, a first wiring 26, a second wiring 28, and a plurality of motor drive devices 50. The rack 24 is a hollow box-shaped member, and the plurality of motor drive devices 50 are accommodated inside the rack 24. Each of the motor drive devices 50 supplies power to the corresponding motor 22 to drive the motor 22. The first wiring 26 electrically connects a pair of the motor drive device 50 and the motor 22 to each other, and transmits a first signal S1 to be communicated between the pair of the motor drive device 50 and the motor 22.

The first signal S1 includes, for example, a power signal Sp for supplying power from the motor drive device 50 to the motor 22, or a feedback signal Sf transmitted from the motor 22 to the motor drive device 50. For example, the motor 22 is provided with a rotation detection sensor (an encoder or a Hall element, or the like) that detects a rotational position (or rotation angle) of the motor 22. The rotation detection sensor transmits a position feedback signal, a speed feedback signal, or an acceleration feedback signal as the feedback signal Sf to the motor drive device 50 through the first wiring 26.

On the other hand, the second wiring 28 electrically connects the motor drive device 50 and another apparatus, and transmits a second signal S2 to be communicated therebetween. Specifically, the second wiring 28 electrically connects the controller 14, the power source 18, and the power source 20 to one motor drive device 50. Also, the second wiring 28 electrically connects one motor drive device 50 and another motor drive device 50.

The second signal S2 includes, for example, a power signal Sw for supplying power to the motor drive device 50 or the control signal Sc described above. The power signal Sw includes, for example, a high-voltage (e.g., 200V or 400V) power signal Sw1 supplied from the power source 18 to each motor drive device 50, and a low-voltage (e.g., 24V) power signal Sw2 supplied from the power source 20 to each motor drive device 50.

The power sources 18 and 20 are installed outside the rack 24. The power source 18 supplies the above-described high-voltage power signal Sw1 as the second signal S2 to each motor drive device 50 through the second wiring 28. On the other hand, the power source 20 supplies the above-described low-voltage power signal Sw2 as the second signal S2 to each motor drive device 50 through the second wiring 28. In addition, the controller 14 supplies the above-described control signal Sc as the second signal S2 to each motor drive device 50 through the second wiring 28.

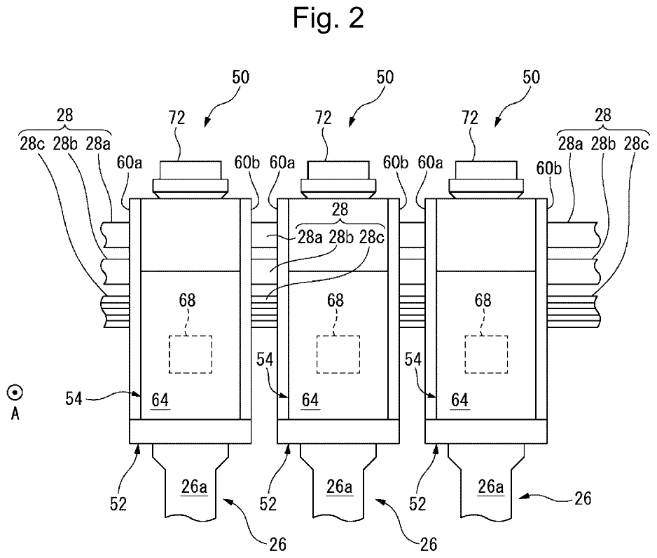

Next, a configuration of the motor drive device 50 will be described with reference to FIGS. 2 to 5. In the following description, the lower side in the gravity direction (that is, the vertically lower side) is referred to as “lower side”, and the direction indicated by arrow A in the drawings is referred to as “front side”. As illustrated in FIG. 2, the plurality of motor drive devices 50 are arranged side by side so as to be adjacent to each other.

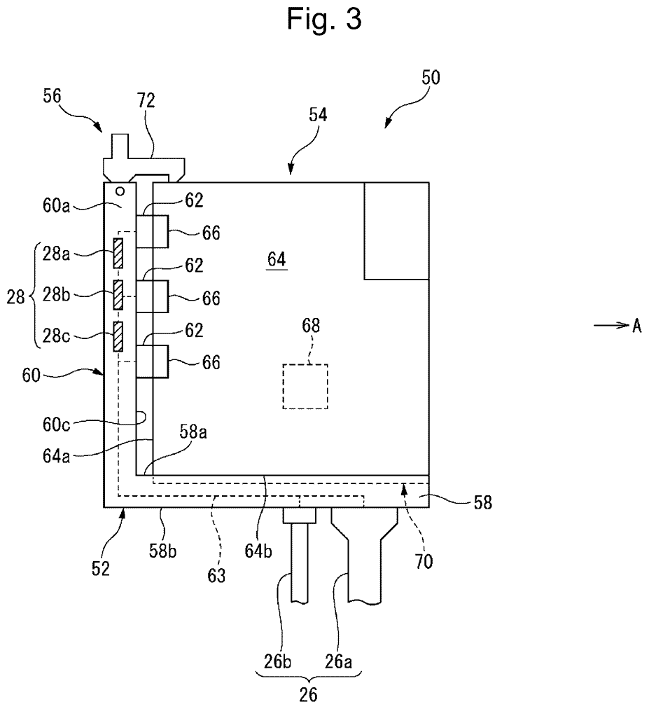

Each of the motor drive devices 50 includes a wiring part 52, a main body 54, and a detachable structure 56. The wiring part 52 is a member having a substantially L-shape when viewed from the side, and is fixed to the rack 24 using a fastener such as a bolt. More specifically, the wiring part 52 includes a seat part 58, a back part 60, wiring-side contacts 62, and a wiring structure 63 (FIG. 3). The seat part 58 is a substantially flat plate-like member and supports the main body 54 from below. The back part 60 is a substantially flat plate-like member, and stands upright from a rear end of the seat part 58 so as to face a rear surface 64a of the main body 54. The seat part 58 and the back part 60 are integrally joined to each other to form a single member having an L-shape in a side view.

The first wiring 26 and the second wiring 28 are connected to the wiring part 52. In the present embodiment, the first wiring 26 includes a power line 26a via which the power signal Sp as the first signal S1 is transmitted, and a signal line 26b via which the feedback signal Sf as the first signal S1 is transmitted. In the present embodiment, the power line 26a and the signal line 26b are connected to a bottom surface 58b of the seat part 58. Note that two connectors (not illustrated) into and from which the power line 26a and the signal line 26b are respectively inserted and removed may be provided on the bottom surface 58b of the seat part 58 so as to face downward.

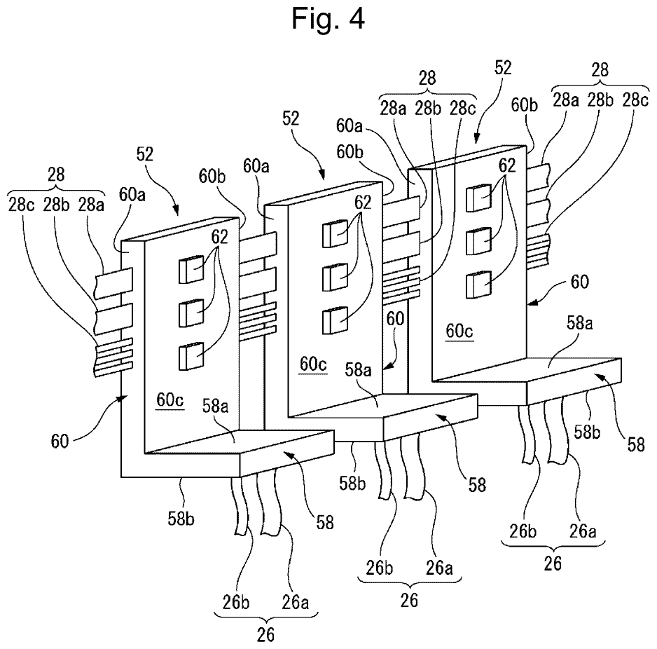

On the other hand, the second wiring 28 includes a power line 28a via which the power signal Sw1 as the second signal S2 is transmitted, a power line 28b via which the power signal Sw2 as the second signal S2 is transmitted, and a signal line 28c via which the control signal Sc as the second signal S2 is transmitted. Each of the power lines 28a and 28b and the signal line 28c are connected to both side surfaces 60a and 60b of the back part 60 (FIGS. 2 and 4). Note that three connectors (not illustrated) into and from which the power lines 28a and 28b and the signal line 28c are respectively inserted and removed may be provided on each of the side surfaces 60a and 60b as to face the side.

One power line 28a connects the power source 18 and one motor drive device 50. Additionally, the other power line 28a connects two motor drive devices 50 arranged adjacent to each other. Similarly, the other power line 28b connects two motor drive devices 50 adjacent to each other while one power line 28b connects the power source 20 and one motor drive device 50.

Additionally, the other signal line 28c connects two motor drive devices 50 adjacent to each other while one signal line 28c connects the controller 14 and one motor drive device 50. Thus, the controller 14, the power source 18, the power source 20, and the plurality of motor drive devices 50 are electrically connected to one another via the second wiring 28 (the power lines 28a and 28b, and the signal line 28c).

The wiring-side contacts 62 are electrical contacts for allowing the first signal S1 (the power signal Sp, the feedback signal Sf, and the like) and the second signal (the power signal Sw1, the power signal Sw2, and the control signal Sc) to communicate with the main body 54. In the present embodiment, the wiring-side contacts 62 are provided on a front surface 60c of the back part 60 and are oriented so as to face forward. The wiring-side contacts 62 are each formed of a conductive member such as a metallic piece (i.e., a terminal), a conductive pad, a plug, or a

For example, the wiring-side contacts 62 may include a first contact 62_{_1} for allowing communication of the power signal Sp, a second contact 62_{_2} for allowing communication of the feedback signal Sf, a third contact 62_{_3} for allowing communication of the power signal Sw1, a fourth contact 62_{_4} for allowing communication of the power signal Sw2, and a fifth contact 62_{_5} for allowing communication of the control signal Sc (none of which are illustrated).

The wiring structure 63 (FIG. 3) is formed of a plurality of conductive wires, a circuit board, or the like, and is embedded in the seat part 58 and the back part 60. The wiring structure 63 electrically connects the first wiring 26 (the power line 26a, the signal line 26b) and the wiring-side contacts 62 (e.g., the first contact 62_{_1}, the second contact 62_{_2}) to each other. The wiring structure 63 electrically connects the second wiring 28 (the power line 28a, the power line 28b, the signal line 28c) and the wiring-side contacts 62 (e.g., the third contact 62_{_3}, the fourth contact 62_{_4}, the fifth contact 62_{_5}) to each other.

More specifically, the wiring structure 63 may include a first conductive wire LN1 connecting the power line 26a and the first contact 62_1, a second conductive wire LN2 connecting the signal line 26b and the second contact 62_{_2}, a third conductive wire LN3 connecting the power line 28a and the third contact 62_{_3}, a fourth conductive wire LN4 connecting the power line 28b and the fourth contact 62_{_4}, and a fifth conductive wire LN5 connecting the signal line 28c and the fifth contact 62_{_5}. In this case, the first conductive wire LN1, the second conductive wire LN2, the third conductive wire LN3, the fourth conductive wire LN4, and the fifth conductive wire LN5 may be insulated from each other. Note that the wiring structure 63 may be embedded in the seat part 58 and the back part 60 such that the entire wiring structure 63 is not exposed to the outside.

The main body 54 is detachably attached to the wiring part 52 and is placed on a top surface 58a of the seat part 58. The main body 54 includes a housing 64 and main body-side contacts 66. The housing 64 is a hollow box-shaped member, and various electronic components 68 are accommodated therein. The electronic components 68 include, for example, a circuit board, a power device, an IC chip, and the like, and process (transmit and receive, convert, amplify, calculate, analyze, and the like) the first signal S1 and the second signal S1.

In the present embodiment, the main body-side contacts 66 are provided on the rear surface 64a of the housing 64 and are oriented so as to face rearward. The main body-side contacts 66 are each formed of a conductive member such as a metallic piece (i.e., a terminal), a conductive pad, a plug, or a connector and electrically connected to the electronic components 68 inside the housing 64. The main body-side contact 66 is brought into conductive contact with the wiring-side contact 62 when the main body 54 is attached to the wiring part 52.

For example, the main body-side contacts 66 may include a first contact 66_{_1} conductively contactable with the first contact 62_{_1} of the wiring-side contact 62, a second contact 66_{_2}conductively contactable with the second contact 62_{_2} of the wiring-side contact 62, a third contact 66_{_3} conductively contactable with the third contact 62_{_3} of the wiring-side contact 62, a fourth contact 66_{_4} conductively contactable with the fourth contact 62_{_4} of the wiring-side contact 62, and a fifth contact 66_{_5} conductively contactable with the fifth contact 62_{_5} of the wiring-side contact 62.

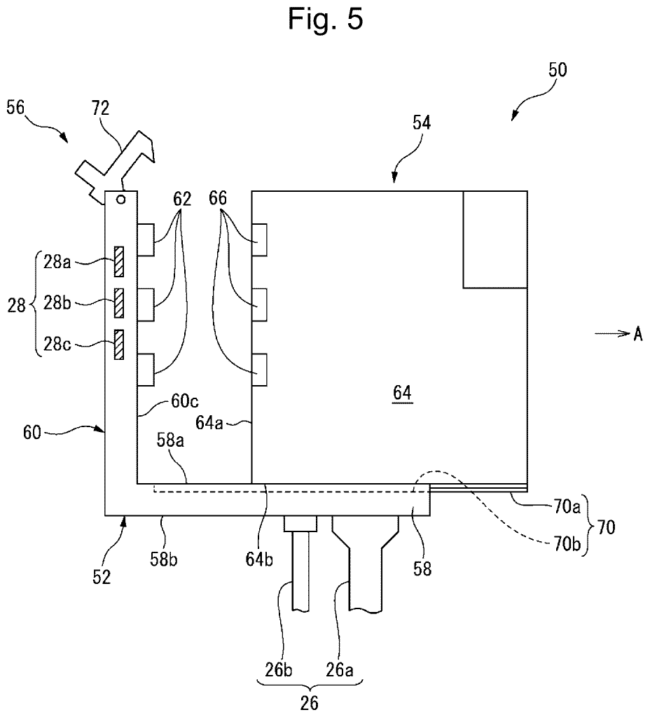

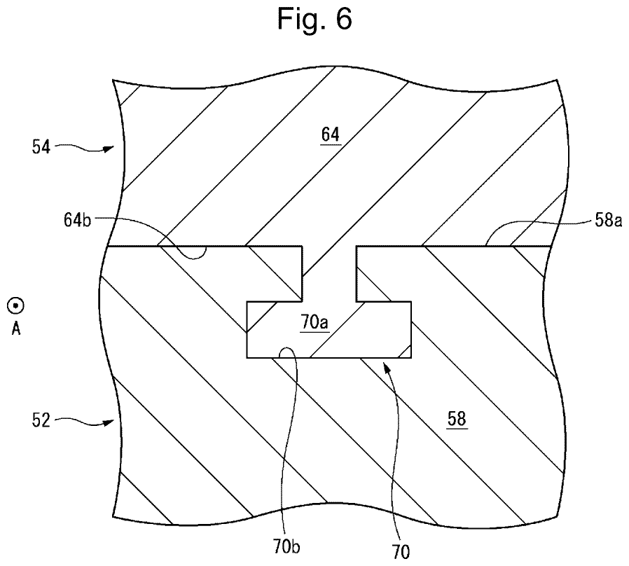

The detachable structure 56 allows the main body 54 to be attached and detached to and from the wiring part 52. Specifically, the detachable structure 56 includes a guide mechanism 70 and a fixture 72. At the time of attaching and detaching the main body 54 to and from the wiring part 52, the guide mechanism 70 guides the movement of the main body 54 with respect to the wiring part 52. As illustrated in FIGS. 5 and 6, the guide mechanism 70 includes a guide rail 70a formed at the housing 64 of the main body 54 and a guide groove 70b formed in the seat part 58 of the wiring part 52.

The guide rail 70a has an outer shape with a substantially T-shaped cross-section, is formed on a bottom surface 64b of the housing 64 so as to protrude downward from the bottom surface 64b, and extends straight in the front-rear direction. On the other hand, the guide groove 70b is formed in the seat part 58 so as to be recessed downward from the top surface 58a of the seat part 58, and extends straight in the front-rear direction. The guide rail 70a is received in the guide groove 70b so as to be slidable relative thereto, and engages with a wall surface defining the guide groove 70b. Thus, the movement of the main body 54 in the front-rear direction relative to the wiring part 52 is guided. Note that the guide rail 70a may be formed on the top surface 58a of the seat part 58 and the guide groove 70b may be formed in the bottom surface 64b of the housing 64.

The fixture 72 releasably fixes the main body 54 to the wiring part 52 at a predetermined attachment position Pa. Specifically, the fixture 72 is formed of a hook mechanism, a latch mechanism, or the like, and detachably engages with an engaged portion (not illustrated) formed at the housing 64 of the main body 54. In the present embodiment, the fixture 72 is provided on the back part 60 of the wiring part 52 so as to be movable between an engagement position in which the fixture 72 engages with the engaged portion of the housing 64 and a disengagement position in which the fixture 72 disengages from the engaged portion. Note that the fixture 72 may be movably provided on the housing 64 and the engaged portion may be provided on the back part 60.

Referring to FIG. 5, at the time of attaching the main body 54 to the wiring part 52, an operator performs an attachment motion M1 of sliding the main body 54 rearward along the top surface 58a of the seat part 58 of the wiring part 52. This attachment motion M1 is guided by the guide mechanism 70. Then, when the main body 54 is arranged at the attachment position Pa illustrated in FIG. 3, the fixture 72 fixes the main body 54 and the wiring-side contact 62 and the main body-side contact 66 are brought into conductive contact with each other. Note that when the wiring-side contact 62 and the main body-side contact 66 are formed of a connector or a plug, the main body-side contact 66 and the wiring-side contact 62 may be arranged such that the main body-side contact 66 is automatically inserted into the wiring-side contact 62 by the attachment motion M1 guided by the guide mechanism 70.

On the other hand, at the time of detaching the main body 54 from the wiring part 52, the operator performs a detachment motion M2 of detaching the main body 54 from the housing 64 by operating the fixture 72 and sliding the main body 54 forward along the top surface 58a of the seat part 58. The detachment motion M2 is also guided by the guide mechanism 70, and the main body-side contacts 66 are separated from the wiring-side contacts 62 by the detachment motion M2. Thus, the operator can easily detach the main body 54 from the wiring part 52.

Next, communication of the first signal S1 and the second signal S1 in the industrial machine system 10 will be described with reference to FIGS. 1 to 3. The power source 18 supplies the power signal Sw1 as the second signal S1 to one motor drive device 50 through the power line 28a of the second wiring 28. The power signal Sw1 is relayed to another adjacent motor drive device 50 through another power line 28a.

Thus, the power signal Sw1 is supplied to each motor drive device 50. The power signal Sw1 supplied to each motor drive device 50 is input to the electronic components 68 through the wiring structure 63, the wiring-side contacts 62, and the main body-side contacts 66. The electronic components 68 process the inputted power signal Sw1 and supply the processed signal as the power signal Sp of the first signal S1 to the motor 22 through the power line 26a of the first wiring 26. The motor 22 is driven by the power signal Sp. Thus, each motor drive device 50 drives the motor 22, and the industrial machine 12 operates.

On the other hand, the power source 20 supplies the power signal Sw2 as the second signal S2 to one motor drive device 50 through the power line 28b of the second wiring 28. The power signal Sw2 is relayed to another adjacent motor drive device 50 through another power line 28b. Thus, the power signal Sw2 is supplied to each motor drive device 50. The power signal Sw2 is supplied to the electronic components 68 through the wiring structure 63, the wiring-side contacts 62, and the main body-side contacts 66, and is used as, for example, driving power for the electronic components 68.

The controller 14 supplies the control signal Sc as the second signal S2 to one motor drive device 50 through the signal line 28c of the second wiring 28. The control signal Sc is relayed to another adjacent motor drive device 50 through another signal line 28c. Thus, the control signal Sc from the controller 14 is supplied to each motor drive device 50 through the signal line 28c.

The electronic components 68 of each motor drive device 50 receive the control signal Sc through the wiring structure 63, the wiring-side contacts 62, and the main body-side contacts 66, and control the timing of supplying the power signal Sp to the motor 22, the waveform of the power signal Sp (for example, the waveform of a PWM signal), or the like in accordance with the control signal Sc. Thus, the operation of the motor 22 driven by each motor drive device 50 is controlled.

On the other hand, the feedback signal Sf transmitted from the motor 22 as the first signal S1 is supplied to the motor drive device 50 through the signal line 26b of the first wiring 26. The electronic components 68 receive the feedback signal Sf through the wiring structure 63, the wiring-side contacts 62, and the main body-side contacts 66. Next, the electronic components 68 transmit the feedback signal Sf to the controller 14 through the main body-side contacts 66, the wiring-side contacts 62, the wiring structure 63, and the signal line 28c of the second wiring 28. Thus, communication of the first signal S1 and the second signal S1 is performed among the controller 14, the power source 18, the power source 20, and the plurality of motor drive devices 50 via the first wiring 26 and the second wiring 28, and the controller 14 controls the operation of the industrial machine 12.

As described above, in the motor drive device 50, the first wiring 26 (the power line 26a, the signal line 26b) via which the first signal S1 (the power signal Sp, the feedback signal Sf) to be communicated with the motor 22 is transmitted and the second wiring 28 via which the second signal S2 (the power signal Sw1, the power signal Sw2, the control signal Sc) communicated with other devices (the controller 14, the power sources 18 and 20, and other motor drive devices 50) is transmitted are connected to the wiring part 52.

The wiring part 52 includes the wiring-side contacts 62 for allowing the first signal S1 and the second signal S2 to communicate with the main body 54 (specifically, the electronic components 68). On the other hand, the main body 54 is detachably attached to the wiring part 52, and incorporates the electronic components 68 that process the first signal S1 and the second signal S2. In addition, the main body 54 includes the main body-side contacts 66 that are brought into conductive contact with the wiring-side contacts 62 when the main body 54 is attached to the wiring part 52.

According to this configuration, the connection of the first wiring 26 for communication with the motor 22 and the connection of the second wiring 28 to the motor drive device 50 for communication with other devices can be concentrated on the wiring part 52. Therefore, for example, when performing work such as maintenance including replacement or repair of the main body 54 (for example, the electronic components 68), the operator does not need to remove the first wiring 26 or the second wiring 28 from the motor drive device 50 in each case, and can perform the work only by detaching the main body 54 from the wiring part 52. As a result, work efficiency can be improved. In addition, the wiring structure of the first wiring 26 and the second wiring 28 can also be simplified.

Further, in the motor drive device 50, the wiring part 52 includes the seat part 58 on which the main body 54 is placed and that supports the main body 54 from below in the gravity direction, and the back part 60 standing upright from the seat part 58 and facing the rear surface 64a of the main body 54. Here, when the motor 22 with high power is driven, the weight of the main body 54 can be relatively large. According to the present embodiment, the weight of the motor drive device 50 can be stably supported by the seat part 58, and thus falling or the like of the main body 54 can be reliably avoided.

Furthermore, in the motor drive device 50, the fixture 72 releasably fixes the main body 54 to the wiring part 52 at the attachment position Pa at which the wiring-side contact 62 and the main body-side contact 66 are brought into conductive contact with each other. According to this configuration, the main body 54 can be stably fixed at the attachment position Pa, and the main body 54 can be easily attached and detached to and from the wiring part 52.

Additionally, in the motor drive device 50, the first signal S1 includes the power signal Sp for supplying power to the motor 22, or the feedback signal Sf from the motor 22. On the other hand, the second signal S2 includes the power signal Sw (the power signal Sw1, the power signal Sw2) for supplying power to other motor drive devices 50 as other devices, or the control signal Sc for controlling the operation of the motors 22 driven by other motor drive devices 50.

Moreover, the motor drive device unit 16 includes the plurality of motor drive devices 50 arranged adjacent to each other, and the second wiring 28 connected to the wiring part 52 of a first motor drive device 50 and the wiring part 52 of a second motor drive device 50 disposed adjacent to the first motor drive device 50 and via which the second signal S2 is transmitted between the two motor drive devices 50.

According to this configuration, the second wiring 28 can be shared among the plurality of motor drive devices 50, and the connection of the second wiring 28 to each of the motor drive devices 50 can be concentrated on the wiring part 52. This makes it possible to further simplify the wiring structure of the second wiring 28 in the motor drive device unit 16. Note that the fixture 72 may be omitted from the motor drive device 50 and the seat part 58 may be omitted from the wiring part 52. In this case, the main body 54 may be fixed to the back part 60, for example, by a fastener such as a bolt.

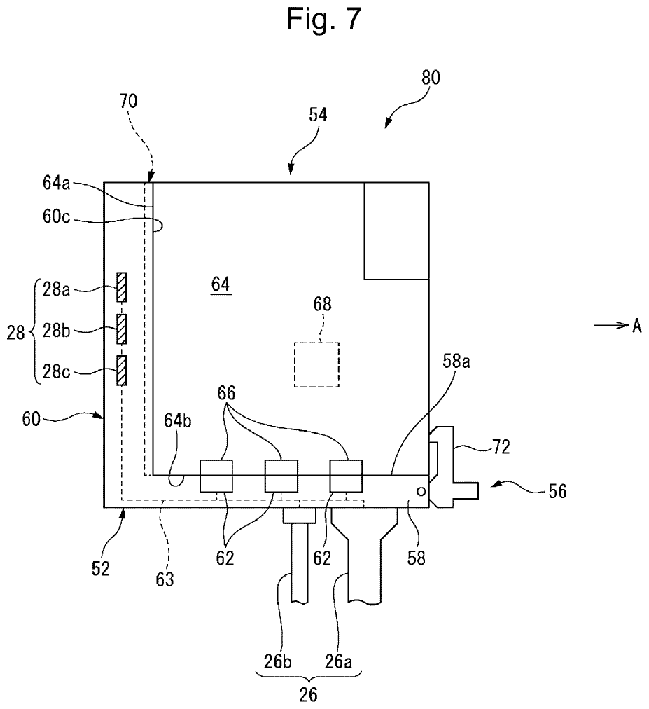

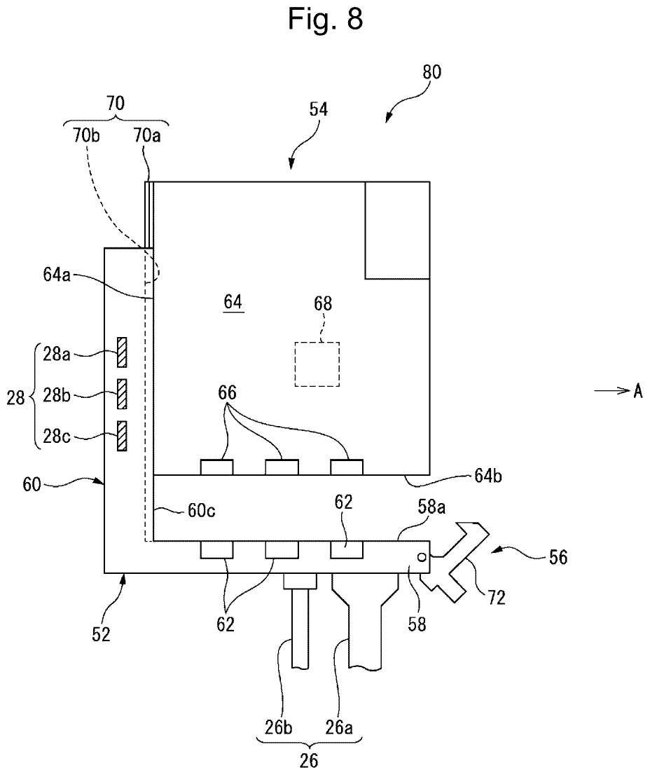

Next, with reference to FIGS. 7 and 8, a motor drive device 80 according to another embodiment will be described. The motor drive device 80 is different from the motor drive device 50 described above in the following configuration. In other words, in the motor drive device 80, the main body-side contacts 66 are disposed on the bottom surface 64b of the housing 64 so as to face downward while the wiring-side contacts 62 are disposed on the top surface 58a of the seat part 58 so as to face upward.

Further, the guide groove 70b is provided in the front surface 60c of the back part 60 while the guide rail 70a of the guide mechanism 70 constituting the detachable structure 56 is provided on the rear surface 64a of the housing 64. Note that the guide rail 70a may be provided on the front surface 60c of the back part 60 and the guide groove 70b may be provided in the rear surface 64a of the housing 64. Furthermore, the fixture 72 constituting the detachable structure 56 is movably provided at a front end of the seat part 58.

In the motor drive device 80, at the time of attaching the main body 54 to the wiring part 52, the operator performs an attachment motion M3 of sliding the main body 54 downward along the front surface 60c of the back part 60. Then, when the main body 54 is arranged at the attachment position Pa illustrated in FIG. 7, the fixture 72 fixes the main body 54, and the wiring-side contacts 62 and the main body-side contacts 66 are brought into conductive contact with each other.

Note that when the wiring-side contact 62 and the main body-side contact 66 are formed of a connector or a plug, the main body-side contact 66 and the wiring-side contact 62 may be arranged such that the main body-side contact 66 is automatically inserted into the wiring-side contact 62 by the attachment motion M3 guided by the guide mechanism 70. In the motor drive device 80, the operator can perform the attachment motion M3 by using the gravity of the main body 54 and thus can easily perform the attachment motion Ma.

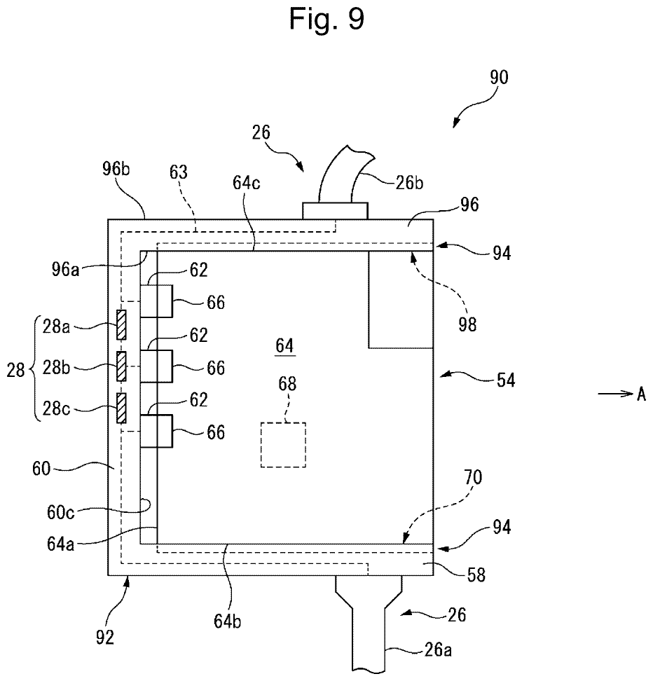

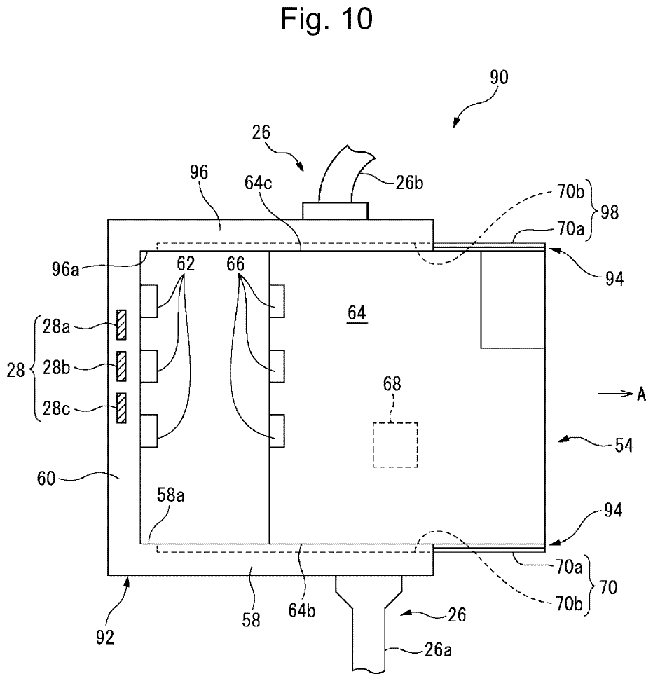

Next, with reference to FIGS. 9 and 10, a motor drive device 90 according to still another embodiment will be described. The motor drive device 90 is different from the motor drive device 50 described above in a wiring part 92 and a detachable structure 94. Specifically, the wiring part 92 further includes a top part 96 in addition to the seat part 58, the back part 60, the wiring-side contacts 62, and the wiring structure 63 described above. The top part 96 extends forward from an upper end of the back part 60 so as to be opposite to the seat part 58 in the up-down direction, and faces a top surface 64c of the housing 64 of the main body 54.

The detachable structure 94 includes the guide mechanism 70 described above and a second guide mechanism 98. As illustrated in FIG. 10, the second guide mechanism 98 includes the guide rail 70a (see FIG. 6) formed so as to protrude upward from the top surface 64c of the housing 64, and the guide groove 70b formed in the top part 96 so as to be recessed upward from a bottom surface 96a of the top part 96.

Similarly to the guide mechanism 70, the guide rail 70a and the guide groove 70b of the second guide mechanism 98 engage with each other and guide the attachment motion M1 of sliding the main body 54 rearward with respect to the wiring part 92. Note that at least one of the guide mechanisms 70 and 98 may be omitted. In addition, the detachable structure 94 may further include the fixture 72 that releasably fixes the main body 54 when the main body 54 is arranged at the attachment position Pa illustrated in FIG. 9.

In the present embodiment, the signal line 26b of the first wiring 26 is connected to a top surface 96b of the top part 96. However, the signal line 26b may be connected to the bottom surface 58b of the seat part 58 as in the motor drive device 50 described above. According to the present embodiment, the main body 54 can be surrounded by the seat part 58, the back part 60, and the top part 96; therefore, the main body 54 can be more stably fixed to the wiring part 92.

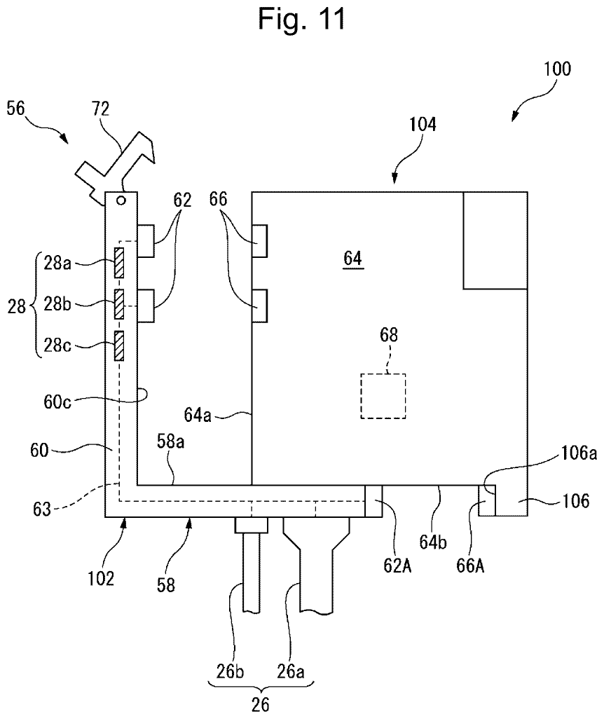

Next, with reference to FIG. 11, a motor drive device 100 according to yet another embodiment will be described. The motor drive device 100 is different from the motor drive device 50 described above in a wiring part 102 and a main body 104. Specifically, the wiring part 102 further includes a wiring-side contact 62A in addition to the seat part 58, the back part 60, the wiring-side contacts 62, and the wiring structure 63 described above. The wiring-side contact 62A is formed of a conductive member such as a metallic piece, a conductive pad, a plug, or a connector, and is provided at the front end of the seat part 58 so as to face forward.

The wiring structure 63 electrically connects the first wiring 26 to the wiring-side contacts 62 and 62A and electrically connects the second wiring 28 to the wiring-side contacts 62 and 62A. For example, any one of the power line 26a, the signal line 26b, the power line 28a, the power line 28b, and the signal line 28c may be connected to the wiring-side contact 62A via the wiring structure 63.

On the other hand, the main body 104 further includes a protrusion 106 and a main body-side contact 66A in addition to the housing 64 and the main body-side contacts 66 described above. The protrusion 106 is formed integrally with the bottom surface 64b of the housing 64 so as to protrude downward from the bottom surface 64b. The main body-side contact 66A is formed of a conductive member such as a metallic piece, a conductive pad, a plug, or a connector, and is provided on a rear surface 106a of the protrusion 106 so as to face rearward. The main body-side contact 66A is electrically connected to the electronic components 68.

The main body-side contact 66A can be brought into conductive contact with the wiring-side contact 62A by the attachment motion M1 of sliding the main body 104 rearward with respect to the wiring part 102. Note that the guide mechanism 70 similar to that of the motor drive device 50 may be applied as the detachable structure 56 to the motor drive device 100. In addition, when the wiring-side contact 62A and the main body-side contact 66A are formed of a connector or a plug, the main body-side contact 66A and the wiring-side contact 62A may be arranged such that the main body-side contact 66A is automatically inserted into the wiring-side contact 62A by the attachment motion M1 guided by the guide mechanism 70.

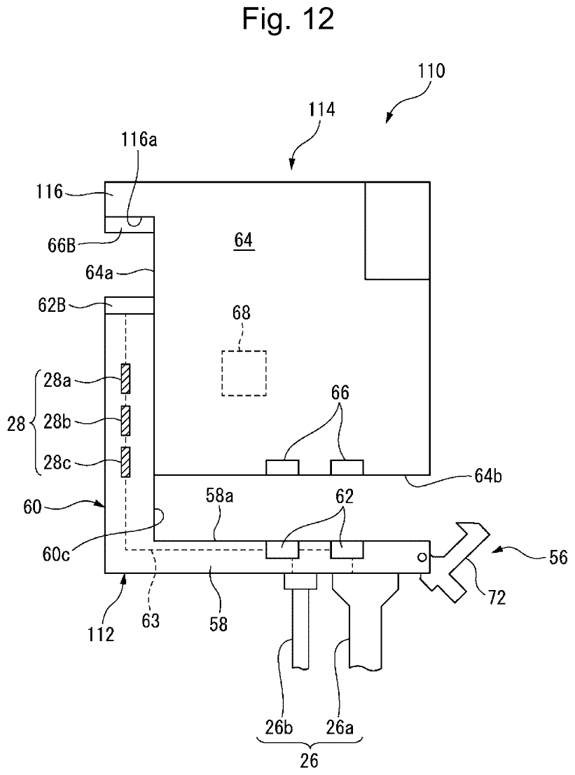

Next, with reference to FIG. 12, a motor drive device 110 according to a further embodiment will be described. The motor drive device 110 is different from the motor drive device 80 of FIG. 7 in a wiring part 112 and a main body 114. Specifically, the wiring part 112 further includes a wiring-side contact 62B in addition to the seat part 58, the back part 60, the wiring-side contacts 62, and the wiring structure 63 described above. The wiring-side contact 62B is formed of a conductive member such as a metallic piece, a conductive pad, a plug, or a connector, and is provided on the upper end of the back part 60 so as to face upward.

The wiring structure 63 electrically connects the first wiring 26 to the wiring-side contacts 62 and the 62B and electrically connects the second wiring 28 to the wiring-side contacts 62 and 62B. For example, any one of the power line 26a, the signal line 26b, the power line 28a, the power line 28b, and the signal line 28c may be connected to the wiring-side contact 62B via the wiring structure 63.

On the other hand, the main body 114 further includes a protrusion 116 and a main body-side contact 66B in addition to the housing 64 and the main body-side contacts 66 described above. The protrusion 116 is formed integrally with the rear surface 64a of the housing 64 so as to protrude rearward from the rear surface 64a. The main body-side contact 66B is formed of a conductive member such as a metallic piece, a conductive pad, a plug, or a connector, and is provided on a bottom surface 116a of the protrusion 116 so as to face downward. The main body-side contact 66B is electrically connected to the electronic components 68.

The main body-side contact 66B can be brought into conductive contact with the wiring-side contact 62B by the attachment motion M3 of sliding the main body 114 downward with respect to the wiring part 112. Note that in the motor drive device 110, the guide mechanism 70 similar to that of the motor drive device 80 of FIG. 7 may be applied as the detachable structure 56. In addition, when the wiring-side contact 62B and the main body-side contact 66B are formed of a connector or a plug, the main body-side contact 66B may be arranged so as to be automatically inserted into the wiring-side contact 62B by the attachment motion M3 guided by the guide mechanism 70.

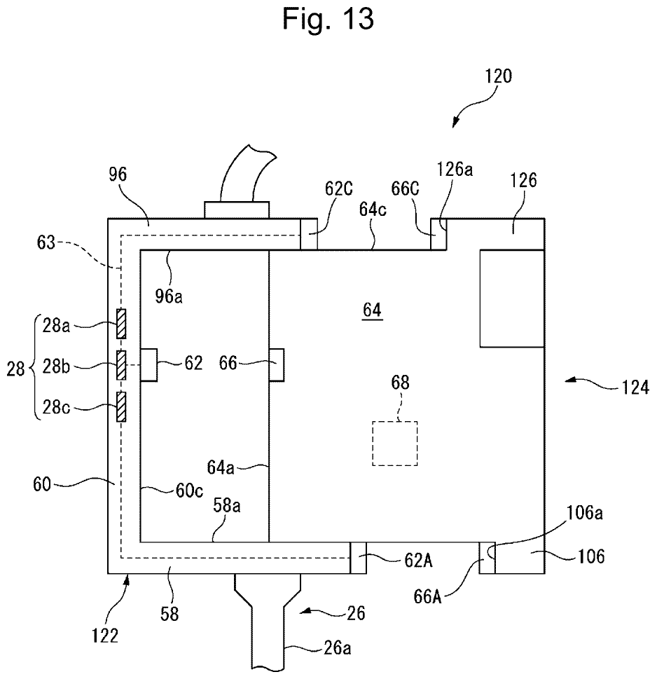

Next, with reference to FIG. 13, a motor drive device 120 according to a still further embodiment will be described. The motor drive device 120 is different from the motor drive device 90 of FIG. 9 and the motor drive device 100 of FIG. 11 in a wiring part 122 and a main body 124. Specifically, the wiring part 122 further includes a wiring-side contact 62C in addition to the seat part 58, the back part 60, the wiring-side contact 62, the wiring structure 63, the top part 96, and the wiring-side contact 62A described above.

The wiring-side contact 62C is formed of a conductive member such as a metallic piece, a conductive pad, a plug, or a connector, and is provided at a front end of the top part 96 so as to face forward. The wiring structure 63 electrically connects the first wiring 26 to the wiring-side contacts 62, 62A, and 62C and electrically connects the second wiring 28 to the wiring-side contacts 62, 62A, and 62C. For example, any one of the power line 26a, the signal line 26b, the power line 28a, the power line 28b, and the signal line 28c may be connected to the wiring-side contact 62C via the wiring structure 63.

On the other hand, the main body 124 further includes a protrusion 126 and a main body-side contact 66C in addition to the housing 64, the main body-side contact 66, the protrusion 106, and the main body-side contact 66A described above. The protrusion 126 is formed integrally with the top surface 64c of the housing 64 so as to protrude upward from the top surface 64c. The main body-side contact 66C is formed of a conductive member such as a metallic piece, a conductive pad, a plug, or a connector, and is provided on a rear surface 126a of the protrusion 126 so as to face rearward. The main body-side contact 66C is electrically connected to the electronic components 68.

The main body-side contact 66C can be brought into conductive contact with the wiring-side contact 62C by the attachment motion M1 of sliding the main body 124 rearward with respect to the wiring part 122. Note that in the motor drive device 120, the guide mechanisms 70 and 98 similar to those of the motor drive device 90 illustrated in FIGS. 9 and 10 may be provided. In addition, when the wiring-side contact 62C and the main body-side contact 66C are formed of a connector or a plug, the main body-side contact 66C and the wiring-side contact 62C may be arranged such that the main body-side contact 66C is automatically inserted into the wiring-side contact 62C by the attachment motion M3 guided by the guide mechanisms 70 and 98.

As described above, in the motor drive device 100, 110, 120 illustrated in FIGS. 11 to 13, the main body 104, 114, 124 includes the housing 64 incorporating the electronic components 68, and the protrusion 106, 116, 126 that protrudes outward (specifically, downward, rearward, and upward) from the housing 64 and on which the main body-side contact 66A, 66B, 66C is arranged.

According to this configuration, the flexibility in arrangement or design of the electronic components 68 inside the housing 64 can be increased. Note that a part of the electronic components 68 (e.g., one IC chip) may be arranged inside the protrusion 106, 116, or 126.

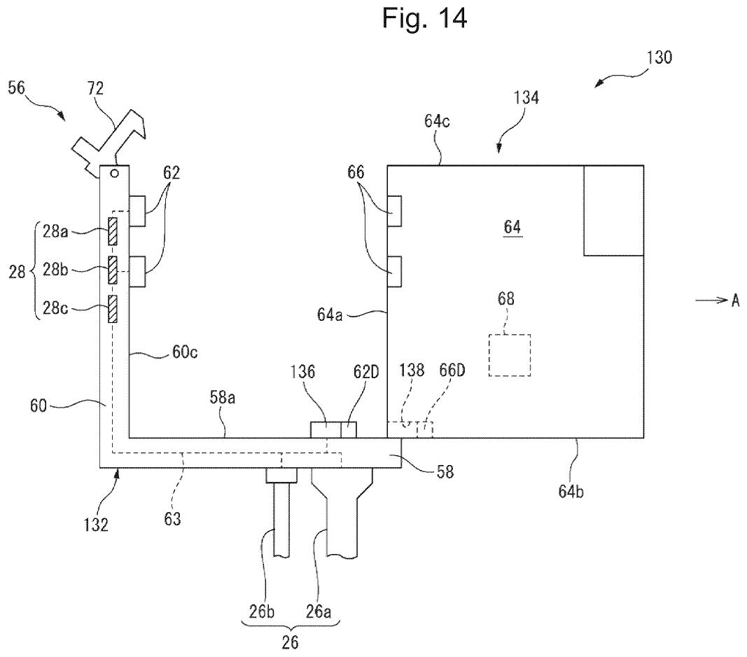

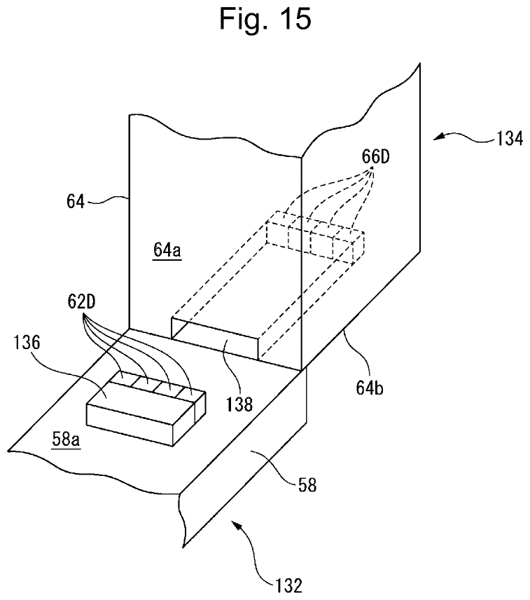

Next, with reference to FIGS. 14 and 15, a motor drive device 130 according to a yet further embodiment will be described. The motor drive device 130 is different from the motor drive device 50 described above in a wiring part 132 and a main body 134. Specifically, the wiring part 132 further includes a protrusion 136 and a wiring-side contact 62D in addition to the seat part 58, the back part 60, the wiring-side contacts 62, and the wiring structure 63 described above. The protrusion 136 is arranged at a position spaced rearward from the front end of the seat part 58, and is provided on the top surface 58a of the seat part 58 so as to protrude upward from the top surface 58a.

In the present embodiment, the wiring-side contact 62D is formed of a connector 62D (wiring-side connector) provided so as to protrude upward from the top surface 58a of the seat part 58. The connector 62D is fixed to a front end of the protrusion 136 so as to face forward. The wiring structure 63 electrically connects the first wiring 26 to the wiring-side contacts 62 and the connector 62D and electrically connects the second wiring 28 to the wiring-side contacts 62 and the connector 62D. For example, any one of the power line 26a, the signal line 26b, the power line 28a, the power line 28b, and the signal line 28c may be connected to the connector 62D via the wiring structure 63.

On the other hand, the main body 134 further includes a groove 138 and a main body-side contact 66D in addition to the housing 64 and the main body-side contacts 66 described above. The groove 138 is formed in the housing 64 so as to be recessed upward from the bottom surface 64b of the housing 64, and extends straight forward from the rear surface 64a of the housing 64. The groove 138 receives the connector 62D slidably relative to the groove 138. In the present embodiment, the main body-side contact 66D is a connector 66D (main body-side connector) insertable and removal into and from the wiring-side connector 62D, and is provided at a front end inside the groove 138 so as to face rearward. The connector 66D is electrically connected to the electronic components 68.

When the operator performs the attachment motion M1 of sliding the main body 134 rearward toward the back part 60 along the top surface 58a of the seat part 58, the connector 62D is received in the groove 138 and moves inside the groove 138 relative thereto. As a result, the connector 62D is inserted into the connector 66D, and both are brought into conductive contact with each other. Note that in the motor drive device 130, the guide mechanism 70 similar to that of the motor drive device 50 may be applied as the detachable structure 56. In addition, the connector 66D and the connector 62D may be arranged such that the connector 62D is automatically inserted into the connector 66D by the attachment motion M1 guided by the guide mechanism 70.

As described above, in the motor drive device 130, the wiring-side contact 62D includes the wiring-side connector 62D provided so as to protrude from the surface of the wiring part 132 (specifically, the top surface 58a of the seat part 58). On the other hand, the main body 134 includes the groove 138 that extends in the direction of attachment and detachment to and from the wiring part 132 (specifically, the front-rear direction) and receives the wiring-side connector 62D.

In addition, the main body-side contact 66D includes the main body-side connector 66D provided inside the groove 138, and the wiring-side connector 62D moves inside the groove 138 relative thereto so as to be connected to the main body-side connector 66D, when the main body 134 is moved toward the wiring part 132 to be attached to the wiring part 132 (when the attachment motion M1 is performed).

According to this configuration, the connectors 62D and 66D can be connected by performing the attachment motion M1, and thus assembly work between the main body 134 and the wiring part 132 can be simplified. Further, the flexibility in arrangement or design of the electronic components 68 can be increased. Note that the protrusion 136 and the connector 62D may be formed on the bottom surface 64b of the housing 64 and the groove 138 and the connector 66D may be formed on the top surface 58a of the seat part 58. In this case, the connector 62D constitutes the main body-side connector, and the connector 66D constitutes the wiring-side connector.

Furthermore, in the motor drive device 130, the top part 96 similar to that of the motor drive device 90 of FIGS. 9 and 10 may be formed at the upper end of the back part 60, and the connector 62D protruding downward from the bottom surface 96a of the top part 96 may be further provided. On the other hand, the groove 138 recessed downward from the top surface 64c of the housing 64 and extending in the front-rear direction may be further provided.

In addition, the connector 66D may be further provided at the front end inside the groove 138. In other words, in this case, the wiring part 132 includes two connectors 62D provided on the seat part 58 and the top part 96. Also, the main body 134 includes two grooves 138 formed in the bottom surface 64b and the top surface 64c of the housing 64, and two connectors 66D provided inside the two grooves 138.

Note that the protrusion 136, the connector 62D, the groove 138, and the connector 66D of the motor drive device 130 can also be applied to the motor drive device 80 of FIGS. 7 and 8. For example, in the motor drive device 80, the protrusion 136 is formed so as to protrude forward from the front surface 60c of the back part 60, and the connector 62D is arranged at an upper end of the protrusion 136 so as to face upward.

On the other hand, the groove 138 recessed forward from the rear surface 64a of the main body 54 and extending in the up-down direction is formed, and the connector 66D is arranged at an upper end inside the groove 138 so as to face downward. In this mode, the connector 62D is automatically inserted into the connector 66D by the attachment motion M3 of sliding the main body 54 downward with respect to the wiring part 52.

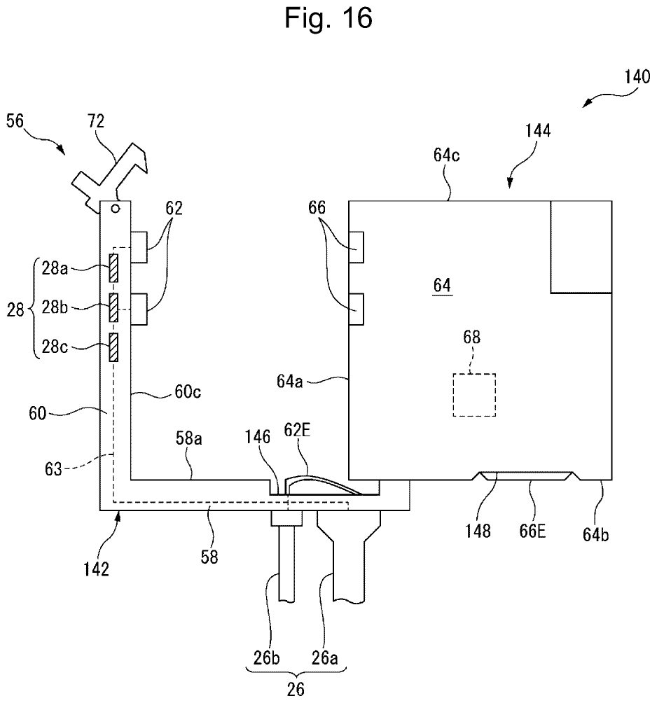

Next, with reference to FIG. 16, a motor drive device 140 according to still another embodiment will be described. The motor drive device 140 is different from the motor drive device 50 described above in a wiring part 142 and a main body 144. Specifically, the wiring part 142 further includes a recess 146 and a wiring-side contact 62E in addition to the seat part 58, the back part 60, the wiring-side contacts 62, and the wiring structure 63 described above. The recess 146 is formed so as to be recessed downward from the top surface 58a of the seat part 58.

In the present embodiment, the wiring-side contact 62E is formed of a spring connector 62E that is elastically deformable in the up-down direction, and is accommodated in the recess 146 such that a part of the wiring-side contact 62E protrudes upward from the top surface 58a. The wiring structure 63 electrically connects the first wiring 26 to the wiring-side contacts 62 and the spring connector 62E and electrically connects the second wiring 28 to the wiring-side contacts 62 and the spring connector 62E. For example, any one of the power line 26a, the signal line 26b, the power line 28a, the power line 28b, and the signal line 28c may be connected to the spring connector 62E via the wiring structure 63.

A plurality of the spring connectors 62E may be arranged side by side in a direction (i.e., the left-right direction) orthogonal to the direction (i.e., the front-rear direction) in which the main body 134 is attached and detached to and from the wiring part 132. In this case, the wiring structure 63 may include the first conductive wire LN1 connecting the power line 26a and the first spring connector 62E, the second conductive wire LN2 connecting the signal line 26b and the second spring connector 62E, the third conductive wire LN3 connecting the power line 28a and the third spring connector 62E, the fourth conductive wire LN4 connecting the power line 28b and the fourth spring connector 62E, and the fifth conductive wire LN5 connecting the signal line 28c and the fifth spring connector 62E. In this case, the first conductive wire LN1, the second conductive wire LN2, the third conductive wire LN3, the fourth conductive wire LN4, and the fifth conductive wire LN5 may be insulated from each other.

On the other hand, the main body 144 further includes a recess 148 and a main body-side contact 66E in addition to the housing 64 and the main body-side contacts 66 described above. The recess 148 is formed so as to be recessed upward from the bottom surface 64b of the housing 64. The main body-side contact 66E is formed of a conductive member having a flat shape, such as a metallic piece or a conductive pad, and is electrically connected to the electronic components 68. The spring connector 62E can be brought into conductive contact with the main body-side contact 66E by the attachment motion M1 of sliding the main body 144 rearward with respect to the wiring part 142.

When the spring connector 62E is brought into conductive contact with the main body-side contact 66E, the spring connector 62E is elastically deformed downward and presses the main body-side contact 66E upward as a reactive force thereof. This makes it possible to stably maintain the conductive contact between the spring connector 62E and the main body-side contact 66E. Note that in the motor drive device 140, the guide mechanism 70 similar to that of the motor drive device 50 may be applied as the detachable structure 56.

Note that the wiring-side contact 62E may be formed of a conductive member such as metallic piece or a conductive pad while the main body-side contact 66E may be formed of a spring connector. Alternatively, both the main body-side contact 66E and the wiring-side contact 62E may be formed of spring connectors. As described above, in the motor drive device 140, one of the wiring-side contact 62E and the main body-side contact 66E includes a spring connector that can be elastically deformed when being brought into conductive contact with the other.

According to this configuration, the main body-side contact 66E and the wiring-side contact 62E can be stably brought into conductive contact with each other.

Note that in the motor drive device 140, the top part 96 similar to that of the motor drive device 90 of FIGS. 9 and 10 may be formed at the upper end of the back part 60 and the recess 146 recessed upward from the bottom surface 96a of the top part 96 may be further provided. In addition, the spring connector 62E may be further disposed in the recess 146. On the other hand, the recess 148 recessed downward from the top surface 64c of the housing 64 may be further provided and the main body-side contact 66E may be further disposed in the recess 148.

In other words, in this case, the wiring part 142 includes two spring connectors 62E provided in the seat part 58 and the top part 96. Also, the main body 144 includes two recesses 148 formed in the bottom surface 64b and the top surface 64c of the housing 64, and two main body-side contacts 66E provided in the two recesses 148.

Note that the recess 146, the spring connector 62E, the recess 148, and the main body-side contact 66E of the motor drive device 140 can also be applied to the motor drive device 80 of FIGS. 7 and 8. For example, in the motor drive device 80, the recess 146 is formed so as to be recessed rearward from the front surface 60c of the back part 60, and the spring connector 62E is arranged in the recess 146. On the other hand, the recess 148 is formed so as to be recessed forward from the rear surface 64a of the main body 54, and the main body-side contact 66E is arranged in the recess 148. In this mode, the spring connector 62E and the main body-side contact 66E can be brought into conductive contact with each other by the attachment motion M3 of sliding the main body 54 downward with respect to the wiring part 52.

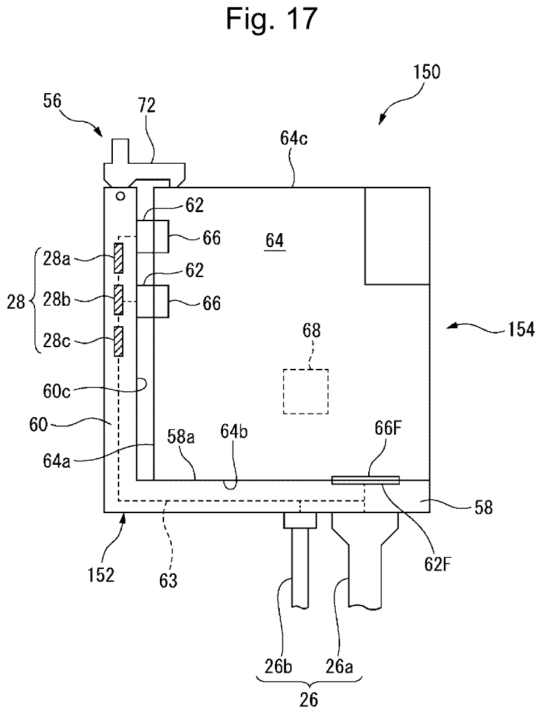

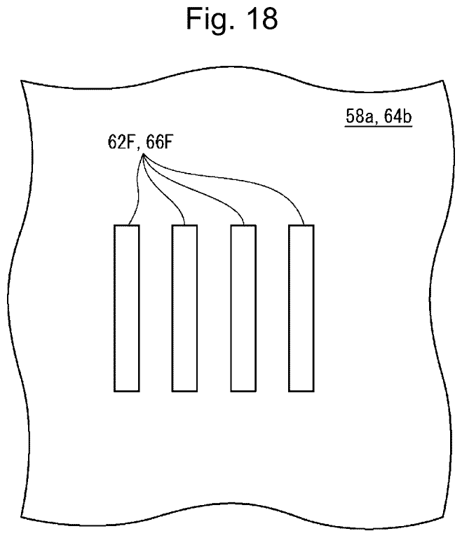

Next, with reference to FIGS. 17 and 18, a motor drive device 150 according to yet another embodiment will be described. The motor drive device 150 is different from the motor drive device 50 described above in a wiring part 152 and a main body 154. Specifically, the wiring part 152 further includes a wiring-side contact 62F in addition to the seat part 58, the back part 60, the wiring-side contacts 62, and the wiring structure 63 described above.

In the present embodiment, the wiring-side contact 62F is formed of a conductive pad 62F (wiring-side conductive pad) arranged along the top surface 58a of the seat part 58. More specifically, the conductive pad 62F is a flat-plate member arranged substantially parallel to the top surface 58a, and protrudes upward from the top surface 58a of the seat part 58. In the present embodiment, a plurality of the conductive pads 62F (four conductive pads in the example of FIG. 18) are arranged in the direction (i.e., the left-right direction) orthogonal to the direction (i.e., the front-rear direction) in which the main body 154 is attached and detached to and from the wiring part 152.

The wiring structure 63 electrically connects the first wiring 26 to the wiring-side contacts 62 and the conductive pad 62F and electrically connects the second wiring 28 to the wiring-side contacts 62 and the conductive pad 62F. For example, any one of the power line 26a, the signal line 26b, the power line 28a, the power line 28b, and the signal line 28c may be connected to the conductive pad 62F via the wiring structure 63.

Note that five or more conductive pads 62F may be disposed on the top surface 58a of the seat part 58. In this case, the wiring structure 63 may include the first conductive wire LN1 connecting the power line 26a and the first conductive pad 62F, the second conductive wire LN2 connecting the signal line 26b and the second conductive pad 62F, the third conductive wire LN3 connecting the power line 28a and the third conductive pad 62F, the fourth conductive wire LN4 connecting the power line 28b and the fourth conductive pad 62F, and the fifth conductive wire LN5 connecting the signal line 28c and the fifth conductive pad 62F. In this case, the first conductive wire LN1, the second conductive wire LN2, the third conductive wire LN3, the fourth conductive wire LN4, and the fifth conductive wire LN5 may be insulated from each other.

On the other hand, the main body 154 further includes a main body-side contact 66F in addition to the housing 64 and the main body-side contacts 66 described above. The main body-side contact 66F is formed of a conductive pad 66F (main body-side conductive pad) similar to the wiring-side conductive pad 62F, and is arranged along the bottom surface 64b of the housing 64. More specifically, the conductive pad 66F is arranged substantially parallel to the bottom surface 64b, and protrudes downward than the bottom surface 64b of the housing 64. The conductive pad 66F is electrically connected to the electronic components 68. The conductive pads 62F and 66F can be brought into conductive contact with each other by the attachment motion M1 of sliding the main body 154 rearward with respect to the wiring part 152. Note that in the motor drive device 150, the guide mechanism 70 similar to that of the motor drive device 50 may be applied as the detachable structure 56.

Note that in the motor drive device 150, the top part 96 similar to that of the motor drive device 90 of FIGS. 9 and 10 may be formed at the upper end of the back part 60 and the conductive pad 62F may be further provided along the bottom surface 96a of the top part 96. On the other hand, the conductive pad 66F may be further provided along the top surface 64c of the housing 64. In other words, in this case, the wiring part 152 includes two conductive pads 62F provided on the seat part 58 and the top part 96. Also, the main body 154 includes two conductive pads 66F provided on the bottom surface 64b and the top surface 64c of the housing 64.

As described above, in the motor drive device 150, the wiring-side contacts 62F include the wiring-side conductive pad 62F that are arranged along the surfaces of the wiring part 152 (e.g., the top surface 58a of the seat part 58 and the bottom surface 96a of the top part 96). In addition, the main body-side contacts 66F include the main body-side conductive pads 66F that are arranged along the surfaces of the main body 154 (e.g., the bottom surface 64b and the top surface 64c of the housing 64) and that are brought into conductive contact with the wiring-side conductive pads 62F when the main body 154 is attached to the wiring part 152 (when the attachment motion M1 is performed). According to this configuration, the flexibility in arrangement or design of the electronic components 68 can be increased.

Note that the conductive pads 62F and 66F of the motor drive device 150 can also be applied to the motor drive device 80 of FIGS. 7 and 8. For example, in the motor drive device 80, the conductive pad 62F is arranged along the front surface 60c of the back part 60. On the other hand, the conductive pad 66F is arranged along the rear surface 64a of the housing 64. In this embodiment, the conductive pads 62F and 66F can be brought into conductive contact with each other by the attachment motion M3 of sliding the main body 54 downward with respect to the wiring part 52.

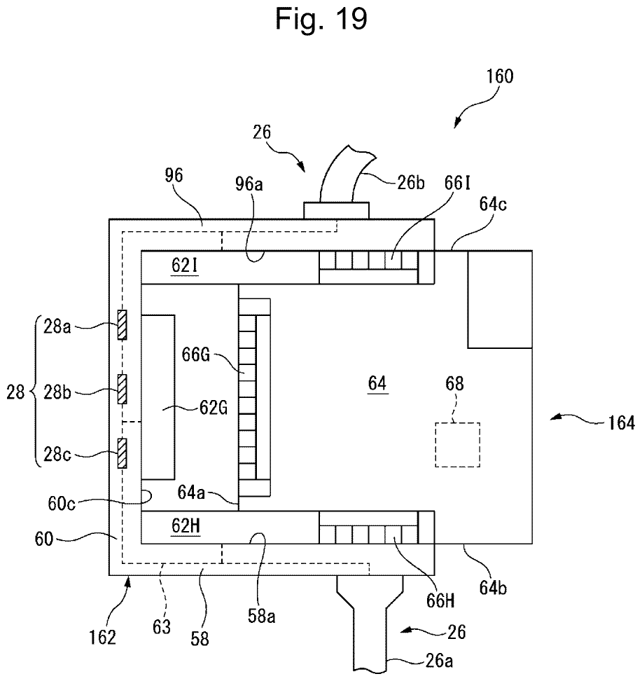

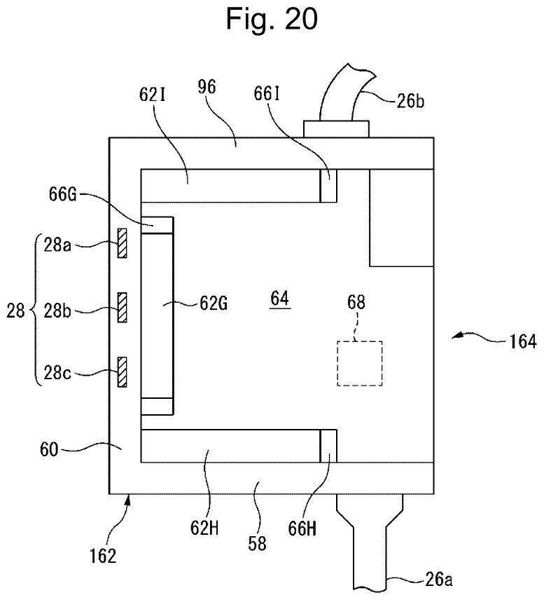

Next, with reference to FIGS. 19 and 20, a motor drive device 160 according to a further embodiment will be described. The motor drive device 160 is different from the motor drive device 90 of FIGS. 9 and 10 in a wiring part 162 and a main body 164. Specifically, the wiring part 162 further includes wiring-side contacts 62G, 62H, and 62I in addition to the seat part 58, the back part 60, the wiring structure 63, and the top part 96 described above.

In the present embodiment, the wiring-side contacts 62G, 62H, and 62I are respectively formed of female connectors 62G, 62H, and 62I. Specifically, the female connector 62G is provided on the front surface 60c of the back part 60, the female connector 62H is provided on the top surface 58a of the seat part 58, and the female connector 62I is provided on the bottom surface 96a of the top part 96. The wiring structure 63 electrically connects the first wiring 26 to the female connectors 62G, 62H, and 62I and electrically connects the second wiring 28 to the female connectors 62G, 62H, and 62I.

Note that each of the female connectors 62G, 62H, and 62I may have a plurality of contacts 62_{_n}. In this case, the wiring structure 63 may include the first conductive wire LN1 connecting the power line 26a and a contact 62_{_11} of the female connector 62H, the second conductive wire LN2 connecting the signal line 26b and a contact 62_{_21} of the female connector 62I, the third conductive wire LN3 connecting the power line 28a and a first contact 62_{_31} of the female connector 62G, the fourth conductive wire LN4 connecting the power line 28b and a second contact 62_{_32} of the female connector 62G, and the fifth conductive wire LN5 connecting the signal line 28c and a third contact 62_{_33} of the female connector 62G. The first conductive wire LN1, the second conductive wire LN2, the third conductive wire LN3, the fourth conductive wire LN4, and the fifth conductive wire LN5 may be insulated from each other.

Alternatively, the first wiring 26 and the second wiring 28 may be connected to one of the female connectors 62G, 62H and 62I (e.g., the female connector 62G). In this case, the wiring structure 63 may include the first conductive wire LN1 connecting the power line 26a and the first contact 62_{_31} of the female connector 62G, the second conductive wire LN2 connecting the signal line 26b and the second contact 62_{_32} of the female connector 62G, the third conductive wire LN3 connecting the power line 28a and the third contact 62_{_33} of the female connector 62G, the fourth conductive wire LN4 connecting the power line 28b and a fourth contact 62_{_34} of the female connector 62G, and the fifth conductive wire LN5 connecting the signal line 28c and a fifth contact 62_{_35} of the female connector 62G.

On the other hand, the main body 164 includes the housing 64 described above and main body-side contacts 66G, 66H, and 66I. The main body-side contacts 66G, 66H, and 66I are respectively formed of male connectors 66G, 66H, and 66I that are insertable and removable into and from the female connectors 62G, 62H, and 62I. Specifically, the male connector 66G is provided on the rear surface 64a of the housing 64, the male connector 66H is provided on the bottom surface 64b of the housing 64, and the male connector 66I is provided on the top surface 64c of the housing 64. The male connectors 66G, 66H and 66I are electrically connected to the electronic components 68.

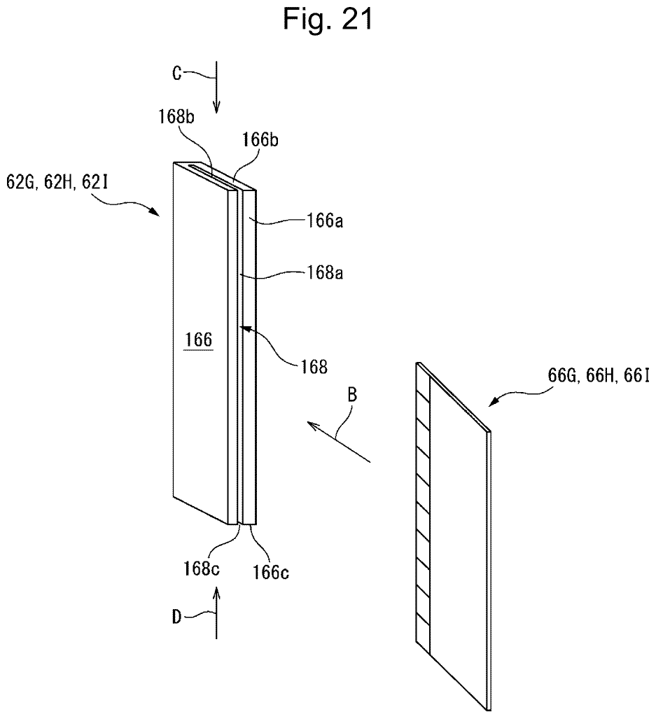

Here, in the present embodiment, the male connectors 66G, 66H, and 66I can be inserted into the female connectors 62G, 62H, and 62I in a first direction B and second directions C and D orthogonal to the first direction B. This configuration will be described with reference to FIGS. 21 to 23. Each of the female connectors 62G, 62H and 62I includes a connector body 166 and a hole 168.

A plurality of electrical contacts are disposed within the hole 168. More specifically, the hole 168 is formed so as to be recessed inward from a front surface 166a of the connector body 166, and extends through the connector body 166 from one end face 166b to the other end face 166c of the connector body 166. Thus, the hole 168 defines an open end 168a at the front surface 166a, an open end 168b at the end face 166b, and an open end 168c at the end face 166c.

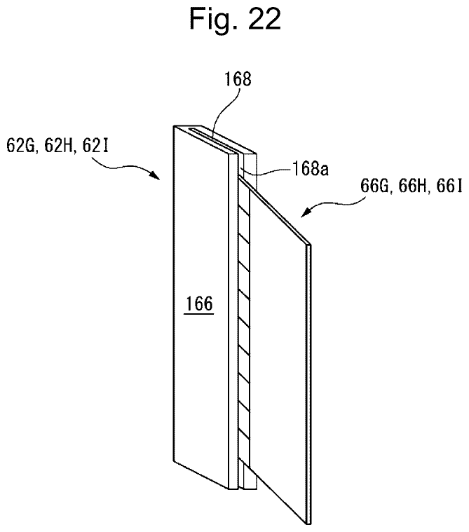

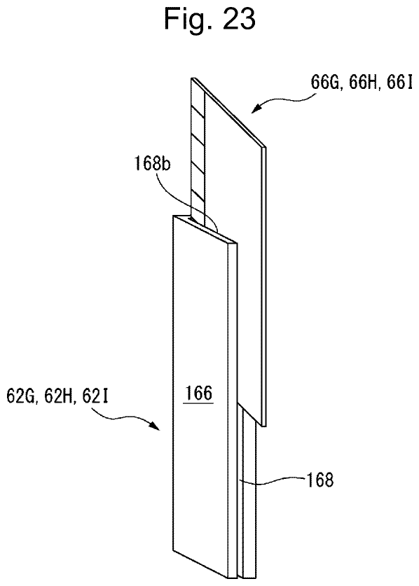

For example, when the male connector 66G is moved in the direction B (first direction) indicated by arrow B in FIG. 21 with respect to the female connector 62G, the male connector 66G can be inserted into the hole 168 from the open end 168a of the female connector 62G as illustrated in FIG. 22. Further, when the male connector 66G is moved in the direction C (second direction) indicated by arrow C in FIG. 21 with respect to the female connector 62G, the male connector 66G can be inserted into the hole 168 from the open end 168b of the female connector 62G as illustrated in FIG. 23.

Furthermore, when the male connector 66G is moved in the direction D (second direction) indicated by arrow D in FIG. 21 with respect to the female connector 62G, the male connector 66G can be inserted into the hole 168 from the open end 168c of the female connector 62G. Thus, the connector 66G can be inserted into the female connector 62G in the first direction B and the second directions C and D orthogonal to the first direction B. Note that the same applies to the male connector 66H and the female connector 62H and to the male connector 66I and the female connector 62I. The hole 168 need not extend to the end face 166b or 166c and need not open at the open end 168b or 168c.

Referring again to FIG. 19, when the operator performs the attachment motion M1 of sliding the main body 164 rearward with respect to the wiring part 162, the male connectors 66H and 66I are inserted into the holes 168 of the female connectors 62H and 62I from the open ends 168b (or 168c). This allows the main body 164 to move rearward relative to the wiring part 162.

Then, when the operator moves the main body 164 further rearward as the attachment motion M1, the male connector 66G is inserted into the hole 168 of the female connector 62G from the open end 168a. As a result, as illustrated in FIG. 20, the main body 164 is arranged at the predetermined attachment position Pa with respect to the wiring part 162, and the male connectors 66G, 66H, and 66I are respectively brought into conductive contact with the female connectors 62G, 62H, and 62I.

Note that in the motor drive device 160, at least two of the male connectors 66G, 66H, and 66I and at least two of the female connectors 62G, 62H, and 62I may be omitted. For example, the male connectors 66H and 66I and the female connectors 62H and 62I may be omitted, or the male connector 66G and the female connector 62G may be omitted.

In addition, in the motor drive device 160, the top part 96 and the female connector 62I may be omitted from the wiring part 162, and the signal line 26b constituting the first wiring 26 may be connected to the bottom surface 58b of the seat part 58. In this case, the operator can attach the main body 164 to the wiring part 162 and bring the male connectors 66G and 66H respectively into conductive contact with the female connectors 62G and 62H by performing either the attachment motion M1 of moving the main body 164 rearward with respect to the wiring part 162 or the attachment motion M3 of moving the main body 164 downward with respect to the wiring part 162.

Alternatively, the operator can also attach the main body 164 to the wiring part 162 by an attachment motion M4 of moving the main body 164 downward and rearward (i.e., obliquely downward toward the rear side) with respect to the wiring part 162. Note that in the motor drive device 160, at least one of the wiring-side contacts 62G, 62H, and 62I may be formed of a male connector and at least one of the main body-side contacts 66G, 66H, and 66I may be formed of a female connector.

As described above, in the motor drive device 160, one of the wiring-side contact 62 and the main body-side contact 66 includes the female connector 62G, 62H, 62I, and the other of the wiring-side contact 62 and the main body-side contact 66 includes the female connector 62G, 62H, 62I that is insertable in the first direction B and the second directions C and D orthogonal to the first direction B.

According to this configuration, as described above, the female connector 62G, 62H, 62I and the female connector 62G, 62H, 62I can be brought into conductive contact with each other by a plurality of the attachment motions M1, M3, and M4 of moving the main body 164 in a plurality of the directions B, C, and D. Therefore, the flexibility in design of the wiring part 162 and the main body 164 and the flexibility in arrangement or design of the electronic components 68 can be increased. Note that in the motor drive device 160, the guide mechanisms 70 and 98 may be applied as the detachable structure 94 as in the motor drive device 90 of FIG. 9 or the fixture 72 releasably fixing the main body 164 at the attachment position Pa may be applied.

Note that in the motor drive device 50, 90, 100, 120, 130, 140, or 150, at least one (e.g., all) of the wiring-side contacts 62 provided on the front surface 60c of the back part 60 may be arranged at a position closer to the lower end of the back part 60 than to the upper end thereof. On the other hand, at least one (e.g., all) of the main body-side contacts 66 provided on the rear surface 64a of the housing 64 may be arranged at a position closer to the bottom surface 64b of the housing 64 than to the top surface 64c thereof. According to this configuration, even when various types of main bodies 54, 104, 124, 134, 144, and 154 having different heights are attached to the wiring parts 52, 102, 122, 132, 142, and 152, at least one of the wiring-side contacts 62 can be reliably brought into conductive contact with at least one of the main body-side contacts 66.

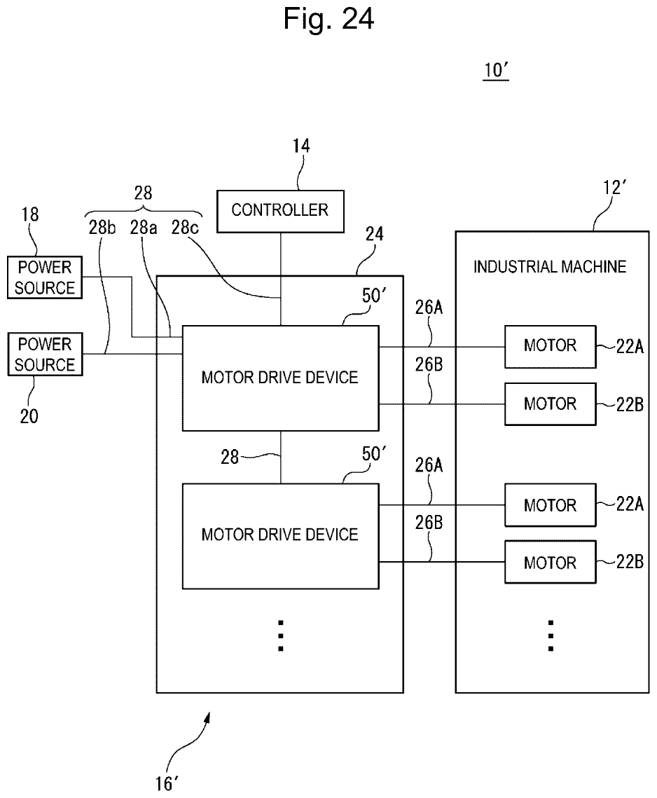

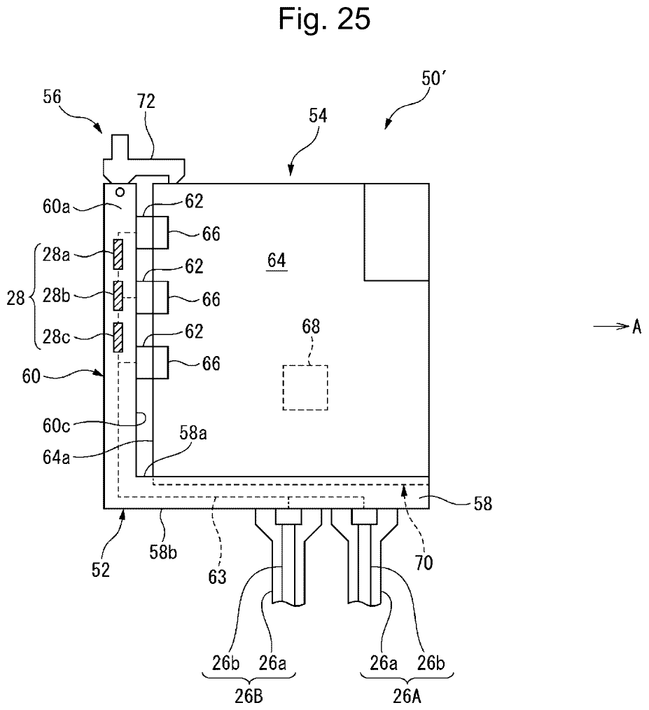

In the embodiments described above, the case in which one motor 22 is connected to one motor drive device 50, 80, 90, 100, 110, 120, 130, 140, 150, and 160 is described. However, no such limitation is intended, and a plurality of the motors 22 may be connected to one motor drive device 50, 80, 90, 100, 110, 120, 130, 140, 150, or 160. Such an embodiment will be described with reference to FIGS. 24 and 25.

An industrial machine system 10′ illustrated in FIG. 24 is different from the industrial machine system 10 illustrated in FIG. 1 in the following configuration. In other words, in the industrial machine system 10′, a motor drive device unit 16′ includes first wirings 26A and 26B and a plurality of motor drive devices 50′ in addition to the rack 24 and the second wiring 28 described above. In the present embodiment, two motors 22A and 22B of an industrial machine 12′ are connected to one motor drive device 50′ via the first wirings 26A and 26B.

As illustrated in FIG. 25, the first wiring 26A extending from the motor 22A and the first wiring 26B extending from the motor 22B are connected to the wiring part 52 of the one motor drive device 50′. The first wiring 26A transmits the first signal S1 communicated between the motor drive device 50′ and the motor 22A, and the first wiring 26B transmits the first signal S1 to be communicated between the motor drive device 50′ and the motor 22B.

More specifically, the first wiring 26A includes the power line 26a via which the power signal Sp is transmitted to the motor 22A and the signal line 26b via which the feedback signal Sf is transmitted to the motor 22A. Similarly, the first wiring 26B includes the power line 26a via which the power signal Sp is transmitted to the motor 22B and the signal line 26b via which the feedback signal Sf is transmitted to the motor 22B.

Each of the motor drive devices 50′ drives the two motors 22A and 22B simultaneously in accordance with the control signal Sc received through the second wiring 28 (specifically, the signal line 28c). Note that three or more motors 22A, 22B, 22C, . . . may be connected to one motor drive device 50′ via three or more first wirings 26A, 26B, 26C, . . . .

As described above, in the present embodiment, a plurality of the first wirings 26A and 26B that extend respectively from a plurality of the motors 22A and 22B and via which the first signals S1 to be communicated with the plurality of motors 22A and 22B are transmitted respectively thereto are connected to the wiring part 52 of the motor drive device 50′. In addition, the motor drive device 50′ is configured to simultaneously drive the plurality of motors 22A and 22B. According to this configuration, the industrial machine 12′ can be diversified; therefore, more complicated operation of the industrial machine 12′ can be realized.

Note that the first wirings 26A and 26B may be applied to the motor drive device 80, 90, 100, 110, 120, 130, 140, 150, or 160 described above. Alternatively, both the first wirings 26A and 26B may be connected to the bottom surface 58b of the seat part 58 of the wiring part 52. Alternatively, in the motor drive device 90, 120, or 160 described above, the first wiring 26B may be connected to the top surface 96b of the top part 96 of the wiring part 52 while the first wiring 26A may be connected to the bottom surface 58b of the seat part 58 of the wiring part 52.

Note that the first signal S1 is not limited to the power signal Sp and the feedback signal Sf and may include any other signal. Also, the second signal S2 is not limited to the power signal Sw and the control signal Sc and may include any other signal. Further, “other devices” to which the second wiring 28 extending from one motor drive device 50 is connected is not limited to other motor drive devices 50, the controller 14, and the power sources 18 and 20, and may be any other type of device. Furthermore, the connection positions of the first wiring 26 and the second wiring 28 to the wiring parts 52, 92, 102, 112, 122, 132, 142, 152, and 162 are not limited to the examples described above, and may be any positions.

In addition, the configurations of the motor drive devices 50, 80, 90, 100, 110, 120, 130, 140, 150, and 160 described above can be combined. For example, the protrusion 106 described above may be applied to the motor drive device 130, 140, 150, or 160. Further, the connectors 62D and 66D and the groove 138 in FIGS. 14 and 15 may be applied to the motor drive device 140, 150, or 160. Furthermore, the spring connector 62E and the main body-side contact 66E in FIG. 16 may be applied to the motor drive device 150 or 160. In addition, the conductive pads 62F and 66F in FIG. 17 may be applied to the motor drive device 160.

The present disclosure is described in detail as above, but is not limited to the above-described individual embodiments. These embodiments may be added, replaced, modified, partially deleted, or the like without departing from the scope of the present disclosure or from the gist of the present disclosure derived from the contents described in the claims and equivalents thereof. Further, these embodiments can also be implemented in combination. For example, in the above-described embodiments, the order of each operation and the order of each process are illustrated as examples and are not limited to these orders. Furthermore, the same applies when numerical values or mathematical formulas are used in the description of the above-described embodiments.

The present disclosure discloses the following aspects.

(Aspect 1) A motor drive device 50, 80, 90, 100, 110, 120, 130, 140, 150, 160 configured to drive a motor 22, the motor drive device 50, 80, 90, 100, 110, 120, 130, 140, 150, 160 including: a wiring part 52, 92, 102, 112, 122, 132, 142, 152, 162 to which a first wiring 26 configured to transmit a first signal S1 communicated with the motor 22 and a second wiring 28 configured to transmit a second signal S2 to be communicated with another apparatus are connected, the wiring part 52, 92, 102, 112, 122, 132, 142, 152, 162 including a wiring-side contact 62, 62A, 62B, 62C, 62D, 62C, 62D, 62E, 62F, 62G, 62H, 62I for communication of the first signal S1 and the second signal S2; and
a main body 54, 104, 114, 124, 134, 144, 154, 164 detachably attached to the wiring part 52, 92, 102, 112, 122, 132, 142, 152, 162 and incorporating an electronic component 68 configured to process the first signal S1 and the second signal S2, the main body 54, 104, 114, 124, 134, 144, 154, 164 including a main body-side contact 66, 66A, 66B, 66C, 66D, 66C, 66D, 66E, 66F, 66G, 66H, 66I brought into conductive contact with the wiring-side contact 62, 62A, 62B, 62C, 62D, 62C, 62D, 62E, 62F, 62G, 62H, 62I when the main body 54, 104, 114, 124, 134, 144, 154, 164 is attached to the wiring part 52, 92, 102, 112, 122, 132, 142, 152, 162.

(Aspect 2) The motor drive device 50, 80, 90, 100, 110, 120, 130, 140, 150, 160 of Aspect 1, wherein the wiring part 52, 92, 102, 112, 122, 132, 142, 152, 162 includes a seat part 58 on which the main body 54, 104, 114, 124, 134, 144, 154, 164 is placed and which supports the main body 54, 104, 114, 124, 134, 144, 154, 164 from below in a gravity direction; and a back part 60 standing upright from the seat part 58 and facing a rear surface 64a of the main body 54, 104, 114, 124, 134, 144, 154, 164.

(Aspect 3) The motor drive device of Aspect 2, wherein the wiring part 92, 122, 162 further includes a top part 96 extending from an upper end of the back part 60 so as to be opposite to the seat part 58, and facing a top surface 64c of the main body 54, 124, 164.

(Aspect 4) The motor drive device 100, 110, 120 of any one of Aspects 1 to 3, wherein the main body 104, 114, 124 includes a housing 64 incorporating the electronic component 68; and a protrusion 106, 116, 126 which protrudes outward from the housing 64 and on which the main body-side contact 66A, 66B, 66C is arranged.

(Aspect 5) The motor drive device 130 of any one of Aspects 1 to 4, wherein the wiring-side contact 62 includes a wiring-side connector 62D provided so as to protrude from a surface 58a of the wiring part 132, wherein the main body 134 includes a groove 138 extending in a direction of attachment and detachment to and from the wiring part 132 and adapted to receive the wiring-side connector 62D, wherein the main body-side contact 66D includes a main body-side connector 66D provided inside the groove 138, and wherein the wiring-side connector 62D moves inside the groove 138 relative to the groove 138 so as to be connected to the main body-side connector 66D, when the main body 134 is moved toward the wiring part 132 to be attached to the wiring part 132.

(Aspect 6) The motor drive device 140 of any one of Aspects 1 to 5, wherein one of the wiring-side contact 62 and the main body-side contact 66 includes a spring connector 62E elastically deformable when the one of the wiring-side contact 62 and the main body-side contact 66 is brought into conductive contact with the other.

(Aspect 7) The motor drive device 150 of any one of Aspects 1 to 6, wherein the wiring-side contact 62 includes a wiring-side conductive pad 62F arranged along a surface 58a of the wiring part 152, and wherein the main body-side contact 66 includes a main body-side conductive pad 66F arranged along a surface 64b of the main body 154 and brought into conductive contact with the wiring-side conductive pad 62F when the main body 154 is attached to the wiring part 152.

(Aspect 8) The motor drive device 160 of any one of Aspects 1 to 7, wherein one of the wiring-side contact 62 and the main body-side contact 66 includes a male connector 66G, 66H, 66I, and wherein the other of the wiring-side contact 62 and the main body-side contact 66 includes a female connector 62H, 62G, 62I into which the male connector 66G, 66H, 66I is insertable in a first direction B and a second direction C, D orthogonal to the first direction B.

(Aspect 9) The motor drive device 50, 80, 90, 100, 110, 120, 130, 140, 150, 160 of any one of Aspects 1 to 8, further including a fixture 72 configured to releasably fix the main body 54, 104, 114, 124, 134, 144, 154, 164 to the wiring part 52, 92, 102, 112, 122, 132, 142, 152, 162 at an attachment position Pa at which the wiring-side contact 62, 62A, 62B, 62C, 62D, 62C, 62D, 62E, 62F, 62G, 62H, 62I and the main body-side contact 66, 66A, 66B, 66C, 66D, 66C, 66D, 66E, 66F, 66G, 66H, 66I are brought into conductive contact with each other.

(Aspect 10) The motor drive device 50′ of any one of Aspects 1 to 9, wherein a plurality of the first wirings 26A, 26B are connected to the wiring part 52, the plurality of the first wirings 26A, 26B extending respectively from a plurality of the motors 22A, 22B and being configured to transmit a plurality of the first signals S1 to be communicated with the plurality of motors 22A, 22B, respectively, and wherein the motor drive device 50′ is configured to simultaneously drive the plurality of motors 22A, 22B.

(Aspect 11) The motor drive device 50, 80, 90, 100, 110, 120, 130, 140, 150, 160 of any one of Aspects 1 to 10, wherein the first signal S1 includes a power signal Sp for supplying power to the motor or a feedback signal Sf from the motor 22, wherein the another apparatus is another motor drive device 50, and wherein the second signal S2 includes a power signal Pw for supplying power to the another motor drive device 50 or a control signal Sc for controlling an operation of another motor 22 driven by the another motor drive device 50.

(Aspect 11) A motor drive device unit 16, including:
a plurality of the motor drive devices 50 of Aspect 10, which are arranged adjacent to each other; and the second wiring 28 connected to the wiring part 52, 92, 102, 112, 122, 132, 142, 152, 162 of a first motor drive device 50 and the wiring part 52, 92, 102, 112, 122, 132, 142, 152, 162 of a second motor drive device 50 arranged adjacent to the first motor drive device 50, the second wiring 28 being configured to transmit the second signal S1 between the first motor drive device 50 and the second motor drive device 50.

### REFERENCE SIGNS LIST

10, 10′ Industrial machine system
12, 12′ Industrial machine
14 Controller
16, 16′ Motor drive device unit
18, 20 Power source
22, 22A, 22B Motor
26 First wiring
28 Second wiring
50, 50′, 80, 90, 100, 110, 120, 130, 140, 150, 160 Motor drive device
52, 92, 102, 112, 122, 132, 142, 152, 162 Wiring part
54, 104, 114, 124, 134, 144, 154, 164 Main body
58 Seat part
60 Back part
62, 62A, 62B, 62C, 62D, 62C, 62D, 62E, 62F, 62G, 62H, 62I Wiring-side contact
64 Housing
66, 66A, 66B, 66C, 66D, 66C, 66D, 66E, 66F, 66G, 66H, 66I Main body-side contact
68 Electronic component
72 Fixture
96 Top part
106, 116, 126, 136 Protrusion
138 Groove

1. A motor drive device configured to drive a motor, the motor drive device comprising:
a wiring part to which a first wiring configured to transmit a first signal to be communicated with the motor and a second wiring configured to transmit a second signal communicated with another apparatus are connected, the wiring part including a wiring-side contact for communication of the first signal and the second signal; and
main body detachably attached to the wiring part and incorporating an electronic component configured to process the first signal and the second signal, the main body including a main body-side contact brought into conductive contact with the wiring-side contact when the main body is attached to the wiring part.

2. The motor drive device of claim 1, wherein the wiring part includes:
a seat part on which the main body is placed and which supports the main body from below in a gravity direction; and
a back part standing upright from the seat part and facing a rear surface of the main body.

3. The motor drive device of claim 2, wherein the wiring part further includes a top part extending from an upper end of the back part so as to be opposite to the seat part, and facing a top surface of the main body.

4. The motor drive device of claim 1, wherein the main body includes:
a housing incorporating the electronic component; and
a protrusion which protrudes outward from the housing and on which the main body-side contact is arranged.

5. The motor drive device of claim 1, wherein the wiring-side contact includes a wiring-side connector provided so as to protrude from a surface of the wiring part,
wherein the main body includes a groove extending in a direction of attachment and detachment to and from the wiring part and adapted to receive the wiring-side connector,
wherein the main body-side contact includes a main body-side connector provided inside the groove, and
wherein the wiring-side connector moves inside the groove relative to the groove so as to be connected to the main body-side connector, when the main body is moved toward the wiring part to be attached to the wiring part.

6. The motor drive device of claim 1, wherein one of the wiring-side contact and the main body-side contact includes a spring connector elastically deformable when the one of the wiring-side contact and the main body-side contact is brought into conductive contact with the other.

7. The motor drive device of claim 1, wherein the wiring-side contact includes a wiring-side conductive pad arranged along a surface of the wiring part, and
wherein the main body-side contact includes a main body-side conductive pad arranged along a surface of the main body and brought into conductive contact with the wiring-side conductive pad when the main body is attached to the wiring part.

8. The motor drive device of claim 1, wherein one of the wiring-side contact and the main body-side contact includes a male connector, and
wherein the other of the wiring-side contact and the main body-side contact includes a female connector into which the male connector is insertable in a first direction and a second direction orthogonal to the first direction.

9. The motor drive device of claim 1, further comprising a fixture configured to releasably fix the main body to the wiring part at an attachment position at which the wiring-side contact and the main body-side contact are brought into conductive contact with each other.

10. The motor drive device of claim 1, wherein a plurality of the first wirings are connected to the wiring part, the plurality of the first wirings extending respectively from a plurality of the motors and being configured to transmit a plurality of the first signals to be communicated with the plurality of motors, respectively, and
wherein the motor drive device is configured to simultaneously drive the plurality of motors.

11. The motor drive device of claim 1, wherein the first signal includes a power signal for supplying power to the motor or a feedback signal from the motor,
wherein the another apparatus is another motor drive device, and
wherein the second signal includes a power signal for supplying power to the another motor drive device or a control signal for controlling an operation of another motor driven by the another motor drive device.

12. A motor drive device unit, comprising:
a plurality of the motor drive devices according to claim 11, which are arranged adjacent to each other; and
the second wiring connected to the wiring part of a first motor drive device and the wiring part of a second motor drive device arranged adjacent to the first motor drive device, the second wiring being configured to transmit the second signal between the first motor drive device and the second motor drive device.
